(19) United States
(12) Patent Application Publication
(10) Pub. No.: US 2025/0269471 A1
(43) Pub. Date: Aug. 28, 2025

(54) LASER PROCESSING MONITORING METHOD AND DEVICE

(71) Applicants: TECH UNIVERSITY OF KOREA INDUSTRY ACADEMIC COOPERATION FOUNDATION, Siheung-si, Gyeonggi-do (KR); RESHENIE CORP., Suwon-si, Gyeonggi-do (KR)

(72) Inventors: Yong Kwan LEE, Suwon (KR); Su Kyung KIM, Suwon (KR)

(21) Appl. No.: 18/858,277

(22) PCT Filed: Dec. 28, 2022
(86) PCT No.: PCT/KR2022/021512

§ 371 Date: Nov. 26, 2024

(30) Foreign Application Priority Data
Sep. 8, 2022 (KR) 10-2022-0114081

(51) Int. Cl. B23K 26/382

(52) U.S. Cl. CPC B23K 26/382

(57) ABSTRACT

The present invention relates to a laser processing monitoring method and apparatus, the method comprising the steps of: irradiating a laser to a target according to a start signal for target processing, receiving reflected light that is the laser reflected by the target, identifying a reflection amount pattern for the reflected light, and detecting whether a hole generated by the laser irradiation is defective based on the reflection amount pattern. In addition, the present invention may have other embodiments.

### TECHNICAL FIELD

The present invention relates to a method and apparatus for monitoring laser processing.

This invention is an invention derived from research conducted as part of the Information, Communication and Broadcasting Innovation Talent Training Project of the National Research Foundation of Korea as follows:
[Task identification number] 1711160332
[Task number] 2020-0-01741-003
[Ministry] Ministry of Science and ICT
[Task Management (Specialized) Organization] National Research Foundation of Korea
[Research Project Name] Information, Communication and Broadcasting Innovation Talent Training (R&D)
[Research Task Name] Grand ICT Research Center
[Contribution Rate] 1/2
[Task Executing Organization] Tech University of Korea Industry Academic Cooperation Foundation
[Research Period] Jan. 1, 2022 ˜ Dec. 31, 2022
[Task identification number] 2022001410
[Task number] RS-2022-00141076
[Ministry] Ministry of SMEs and Startups
[Task Management (Specialized) Organization] Korea Technology and Information Promotion Agency for SMEs
[Research Project Name] Smart Manufacturing Innovation Technology Development Project
[Research Task Name] Development of Integrated Solution for Monitoring DPT-based Equipment Status through Demonstration of Electrical and Electronic Parts Industry
[Contribution Rate] 1/2
[Task Executing Organization] Reshenie Corp.
[Research Period] Apr. 29, 2022-Dec. 31, 2025

### BACKGROUND ART

In microprocessing of semiconductors, displays, etc., laser devices are often used for machining substrate surface materials or via holes, or forming specific patterns. To this end, technologies for processing laser beams into special shapes, technologies for shaping the spatial shapes of lasers into lines, planes, etc., that is, technologies for maintaining the spatial intensity of beams in a specific shape or minimizing the transition width of the edge portion, etc., are being developed.

However, the characteristics of the laser beam shaped precisely in this way may be modified by environmental factors, etc. to be different from the initial recipe setting before being irradiated onto the imaging surface, i.e., the target, thereby resulting in a problem that an abnormality occurs in the processed article. In particular, when using ultra-precision laser processing equipment, the processing quality inspection is mostly performed after the process is completed, so it is difficult to correct or rework defective molds, thereby resulting in high costs for mold disposal.

### DISCLOSURE

### Technical Problem

Embodiments of the present invention for solving these conventional problems are to provide a laser processing monitoring method and apparatus capable of checking for processing defects in real time according to the type of a target during processing of the target.

In addition, embodiments of the present invention are to provide a laser processing monitoring method and apparatus capable of omitting a separate defect inspection process for defect inspection by checking for processing defects in real time during processing of a target.

### Technical Solution

A method for monitoring laser processing according to an embodiment of the present invention may include irradiating a laser to a target according to a start signal for target processing, receiving reflected light that is the laser reflected by the target, identifying a reflection amount pattern for the reflected light, and detecting whether a hole generated by the laser irradiation is defective based on the reflection amount pattern.

In addition, the identifying the reflection amount pattern for the reflected light may include comparing a previously stored learning pattern with the identified reflection amount pattern, and confirming that a defect has occurred in the hole if the learning pattern and the reflection amount pattern differ by a threshold or more.

In addition, the method may further include storing the learning pattern in consideration of the type of the target.

In addition, the method may further include storing the learning pattern in consideration of the hole spacing and the hole diameter.

In addition, the storing the learning pattern may include storing the learning pattern generated using an unsupervised autoencoder.

In addition, an apparatus for monitoring laser processing includes a processing unit configure to a light source for irradiating a laser to a target, and a light receiver for receiving reflected light that is the laser reflected by the target; and a controller configure to control the processing unit to irradiate the laser, to identify the reflection amount pattern for the reflected light received from the light receiver, and to detect whether a hole generated by the laser irradiation is defective based on the reflection amount pattern.

In addition, the controller may be configured to compare a previously stored learning pattern with the identified reflection amount pattern to confirm that a defect has occurred in the hole if they differ by a threshold or more.

In addition, the apparatus may further include a memory, and wherein the controller configured to store the learning pattern in the memory in consideration of the type of the target.

In addition, the controller may be configured to store the learning pattern in the memory in consideration of the hole spacing and the hole diameter.

In addition, the controller may be configured to generate the learning pattern using an unsupervised autoencoder.

### Advantageous Effects

The laser processing monitoring method and apparatus according to the present invention as described above can check for processing defects in real time according to the type of a target during processing of the target, and thus can omit a separate defect inspection process, thereby having the effects of being able to check the type and characteristics of defects according to the type of the target, and to minimize the time spent in the defect inspection process.

### DESCRIPTION OF DRAWINGS

FIG. 1 is a view showing an electronic apparatus for laser processing monitoring according to an embodiment of the present invention.

FIG. 2 is a flowchart for explaining a method for performing laser processing monitoring according to an embodiment of the present invention.

### BEST MODES OF THE INVENTION

Hereinafter, preferred embodiments according to the present invention will be described in detail with reference to the accompanying drawings. The detailed description set forth below together with the accompanying drawings is intended to explain exemplary embodiments of the present invention and is not intended to represent the only embodiments in which the present invention may be practiced. In order to clearly describe the present invention in the drawing, parts irrelevant to the description may be omitted; and the same reference numerals may be used for identical or similar components throughout the specification.

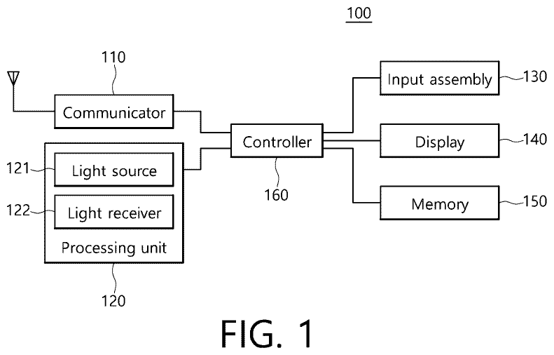

FIG. 1 is a view showing an electronic apparatus for laser processing monitoring according to an embodiment of the present invention.

Referring to FIG. 1, the electronic apparatus 100 according to the present invention may include a communicator 110, a processing unit 120, an input assembly 130, a display 140, a memory 150, and a controller 160, wherein the processing unit 120 may include a light source 121 and a light receiver 122.

The communicator 110 may receive a learning pattern (hereinafter, referred to as learning data) from an external server (not shown) through communication with the external server. To this end, the communicator 110 may perform wireless communication, such as 5^{th} generation communication (5G), long term evolution-advanced (LTE-A), long term evolution (LTE), and wireless fidelity (Wi-Fi), with the external server.

In this case, the learning data is learning data in which processing conditions and learning patterns are mapped, and may be generated using an AI algorithm stored in the external server. The processing conditions are conditions for the type of a target (e.g., metal, ceramic, etc.), the thickness of the target, a via hole spacing, a via hole diameter, and the number of via holes, and the learning pattern may be a pattern generated by learning a reflection amount pattern when the target is normally processed according to the processing conditions.

In addition, the external server may apply the normal reflection amount pattern acquired from the electronic apparatus 100 to the AI algorithm as input when the target is normally processed. In addition, the external server may apply the processing conditions for the environment set when processing the target, i.e., the type of the target, the thickness of the target, the via hole spacing, the via hole diameter, and the number of via holes, and the reflection amount pattern as inputs to the AI algorithm to generate an autoencoder model, which is an artificial neural network trained in an unsupervised manner, and may use the same to generate the learning data in which the processing conditions and learning patterns are mapped.

The processing unit 120 may include a light source 121 for irradiating laser light (hereinafter, collectively referred to as laser) and a light receiver 122 for receiving reflected light. The laser irradiated from the light source 121 is reflected by a target to generate reflected light, and the light receiver 122 receives the reflected light generated by being reflected by the target. Here, the light source 121 may be formed to have a plurality of light sources so that it can irradiate according to the number of via holes included in the processing conditions. The light receiver 122 generates light-receiving data using the received reflected light and provides it to the controller 160. Here, the light receiver 122 may refer to a photo diode sensor, etc.

The input assembly 130 generates input data in response to an input of an operator operating the electronic apparatus 100. The input assembly 130 may include at least one input means among a key pad, a dome switch, a touch panel, a touch key, and a button.

The display 140 outputs output data according to the operation of the electronic apparatus 100. To this end, the display 140 may include a liquid crystal display (LCD), a light emitting diode (LED) display, an organic light emitting diode (OLED) display, a micro electro mechanical systems (MEMS) display, and an electronic paper display. The display 140 may be implemented as a touch screen by combining with the input assembly 130.

The memory 150 stores operation programs of the electronic apparatus 100. The memory 150 may store an algorithm for generating a reflection amount pattern based on the light-receiving data generated by the light receiver 122, and an algorithm for generating learning data with the reflection amount pattern. The memory 150 may store learning data in which a learning pattern is mapped when the target is normally processed according to processing conditions such as the type of the target, the thickness of the target, the via hole spacing, the via hole diameter, and the number of via holes. Here, the learning pattern refers to a pattern in which the reflection amount pattern is learned when the target is normally processed according to the processing conditions.

The controller 160 may generate learning data through a test and store it in the memory 150, and may store learning data received from the external server through communication with the external server in the memory 150. In order to generate learning data, the controller 160 may call an AI algorithm stored in the memory 150 and apply a normal reflection amount pattern acquired when the target is normally processed as an input of the AI algorithm. In addition, the controller 160 may apply the processing conditions for the environment set when processing the target, i.e., the type of the target, the thickness of the target, the via hole spacing, the via hole diameter, and the number of via holes as inputs to the AI algorithm to generate an autoencoder model, which is an artificial neural network trained in an unsupervised manner.

The controller 160 controls the processing unit 120 to irradiate a laser to the target. The controller 160 identifies the reflection amount pattern using the light-receiving data generated by the light receiver 122 that receives the reflected light which is a laser reflected by the target. The controller 160 can detect whether there is a defect that occurred due to laser irradiation during target processing based on the identified reflection amount pattern.

More specifically, when the controller 160 receives a processing start signal for processing the target with a laser from the input assembly 130, the controller 160 controls the light source 121 according to the processing start signal to irradiate the laser to the target. Here, the processing start signal may include the processing conditions for the type of the target to be processed, the thickness of the target, the via hole spacing, the via hole diameter, the number of via holes, etc. The laser irradiated from the light source 121 is reflected by the target to generate reflected light. The generated reflected light is received by the light receiver 122, and the light receiver 122 generates light-receiving data based on the reflected light. The light receiver 122 provides the identified light-receiving data to the controller 160.

The controller 160 identifies the reflection amount pattern for the reflected light using the received light-receiving data. In this case, when the laser is first irradiated to the target, the reflected light may be the largest, and when processing such as a via hole on the target is completed, the reflected light may be the smallest. That is, the size of the reflected light may gradually decrease as the time elapses while the laser is irradiated to the target. The controller 160 may identify the reflection amount pattern for the reflected light generated as the time elapses while the laser is irradiated to the target.

The controller 160 calls the learning data previously stored in the memory 150. The controller 160 compares the identified reflection amount pattern with the learning pattern included in the called learning data. The controller 160 identifies the learning pattern mapped to the same processing condition as the processing condition included in the processing start signal among the learning data. In this case, the controller 160 may compare the identified reflection amount pattern with the called learning pattern. When the difference between the two reflection amount patterns is greater than or equal to a threshold, the controller 160 may confirm that a defect has been detected during processing of the target and display it on the display 140.

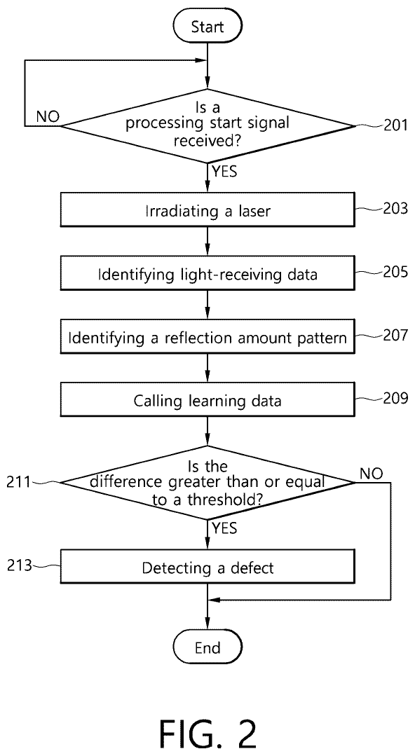

FIG. 2 is a flowchart for explaining a method for performing laser processing monitoring according to an embodiment of the present invention.

Referring to FIG. 2, in step 201, if the controller 160 receives a processing start signal for processing a target with a laser from the input assembly 130, it performs step 203, and if it does not receive the processing start signal, it waits for the reception of the processing start signal. Here, the processing start signal may include the processing conditions for the type of the target to be processed, the thickness of the target, the via hole spacing, the via hole diameter, the number of via holes, etc.

In step 203, the controller 160 controls the light source 121 according to the received processing start signal to irradiate a laser to the target. In step 205, the controller 160 receives and identifies the light-receiving data generated by the light receiver 122. More specifically, the laser irradiated to the target is reflected by the target to generate reflected light, and the light receiver 122 generates the light-receiving data based on the received reflected light and provides it to the controller 160.

In step 207, the controller 160 identifies the reflection amount pattern for the reflected light using the received light-receiving data. In this case, when the laser is first irradiated to the target, the reflected light may be the largest, and when processing such as a via hole on the target is completed, the reflected light may be the smallest. That is, the size of the reflected light may gradually decrease as the time elapses while the laser is irradiated to the target. The controller 160 may identify the reflection amount pattern for the reflected light generated as the time elapses while the laser is irradiated to the target.

In step 209, the controller 160 calls the learning data previously stored in the memory 150. In this case, the controller 160 may call the learning data having the same processing conditions as the type of the target to be processed, the thickness of the target, the via hole spacing, the via hole diameter, and the number of via holes included in the processing start signal received in step 201. In step 211, the controller 160 compares the reflection amount pattern identified in step 207 with the learning pattern included in the learning data called in step 209.

As a result of the comparison in step 211, if the difference between the reflection amount pattern identified in step 207 and the called learning pattern is greater than or equal to a threshold, the controller 160 performs step 213, and if the difference is less than the threshold, the process may be terminated. In step 213, the controller 160 may confirm that a defect has been detected during processing of the target and display it on the display 140.

The embodiments of the present invention disclosed in the specification and drawings merely provide specific examples to easily explain the technical content of the present invention and to aid understanding of the present invention, and are not intended to limit the scope of the present invention. Therefore, the scope of the present invention should be interpreted as including all changed or modified forms derived based on the technical idea of the present invention in addition to the embodiments disclosed herein.

1. A method for monitoring laser processing, the method comprising:
irradiating a laser to a target according to a start signal for target processing,
receiving reflected light that is the laser reflected by the target,
identifying a reflection amount pattern for the reflected light, and
detecting whether a hole generated by the laser irradiation is defective based on the reflection amount pattern.

2. The method of claim 1, wherein the identifying the reflection amount pattern for the reflected light comprises:
comparing a previously stored learning pattern with the identified reflection amount pattern; and
confirming that a defect has occurred in the hole if the learning pattern and the reflection amount pattern differ by a threshold or more.

3. The method of claim 2, further comprising:
storing the learning pattern in consideration of the type of the target.

4. The method of claim 3, further comprising:
storing the learning pattern in consideration of the hole spacing and the hole diameter.

5. The method of claim 4, wherein the storing the learning pattern comprises:
storing the learning pattern generated using an unsupervised autoencoder.

6. An apparatus for monitoring laser processing, the apparatus comprising:
a processing unit configured to a light source for irradiating a laser to a target, and a light receiver for receiving reflected light that is the laser reflected by the target; and
a controller configured to control the processing unit to irradiate the laser, to identify the reflection amount pattern for the reflected light received from the light receiver, and to detect whether a hole generated by the laser irradiation is defective based on the reflection amount pattern.

7. The apparatus of claim 6, wherein the controller is configured to compare a previously stored learning pattern with the identified reflection amount pattern to confirm that a defect has occurred in the hole if they differ by a threshold value or more.

8. The apparatus of claim 7, further comprising:
a memory; and
wherein the controller is configured to store the learning pattern in the memory in consideration of the type of the target.

9. The apparatus of claim 8, wherein the controller is configured to store the learning pattern in the memory in consideration of the hole spacing and the hole diameter.

10. The apparatus of claim 9, wherein the controller generates the learning pattern using an unsupervised autoencoder.
